(19) United States
(12) Patent Application Publication
(10) Pub. No.: US 2026/0088044 A1
(43) Pub. Date: Mar. 26, 2026

(54) FLEXURE WITH VARYING THICKNESS FOR MAGNETIC STORAGE DEVICE

(71) Applicant: Western Digital Technologies, Inc., San Jose, CA (US)

(72) Inventors: Yoshinobu Noguchi, Yokohama-shi (JP); Hiroyasu Tsuchida, Fujisawa (JP); Kia Teo, San Jose, CA (US); Kohei Arakawa, Yokohama-shi (JP)

(21) Appl. No.: 18/895,182

(22) Filed: Sep. 24, 2024

(51) Int. Cl. G11B 5/48

(52) U.S. Cl. CPC G11B 5/4826; G11B 5/4833

(57) ABSTRACT

Examples of the present disclosure include a head-gimbal assembly for a magnetic storage device. The head-gimbal assembly includes a load beam, a read-write head, and an actuator configured to cause the read-write head to move. The head-gimbal assembly includes a flexure attached to the actuator. The flexure includes an actuator side facing the actuator and a recess formed in the actuator side and at least partially overlapping with the actuator along a virtual plane that is substantially perpendicular to a length of the load beam.

### FIELD

This disclosure relates generally to magnetic storage devices, and more particularly to flexures with varying thicknesses for magnetic storage devices.

### BACKGROUND

Magnetic storage devices, such as hard disk drives (“HDDs”), are widely used to store digital data or electronic information for enterprise data processing systems, computer workstations, portable computing devices, digital audio players, digital video players, and the like. Generally, HDDs include read-write heads that help facilitate storage of data on magnetic disks. Each read-write head is supported on a suspension assembly. Some HDDs include a suspension assembly with a flexure.

### SUMMARY

A need exists for a magnetic storage device and a method of manufacture that help to reduce flexure-actuator contact. The subject matter of the present application has been developed in response to the present state of magnetic storage devices, and in particular, in response to problems and needs in the art, such as those discussed above, that have not yet been fully solved by currently available magnetic storage devices. Accordingly, the examples of the present disclosure overcome at least some of the shortcomings of the prior art.

The following is a non-exhaustive list of examples, which may or may not be claimed, of the subject matter disclosed herein.

Disclosed herein is a head-gimbal assembly for a magnetic storage device. The head-gimbal assembly includes a load beam, a read-write head, an actuator configured to cause the read-write head to move, and a flexure attached to the actuator. The flexure includes an actuator side facing the actuator. The flexure also includes a recess formed in the actuator side and at least partially overlapping with the actuator along a virtual plane that is substantially perpendicular to a length of the load beam. The preceding subject matter of this paragraph characterizes example 1 of the present disclosure.

The head-gimbal assembly further includes an adhesive disposed between the actuator and the flexure at a location within the recess such that the adhesive partially fills the recess. The adhesive is made of an electrically conductive material. The preceding subject matter of this paragraph characterizes example 2 of the present disclosure, wherein example 2 also includes the subject matter according to example 1, above.

A ratio between a thickness of a non-recessed portion of the flexure, immediately adjacent to the recess, to a thickness of a recessed portion of the flexure, defined by the recess, is between, and inclusive of, 1.2 and 5.0. The preceding subject matter of this paragraph characterizes example 3 of the present disclosure, wherein example 3 also includes the subject matter according to any one of examples 1-2, above.

The flexure includes a first flexure-layer made of a first material and a second flexure-layer made of a second material that is different than the first material. The recess is formed in the second flexure-layer. The flexure is attached to the load beam such that the first flexure-layer is interposed between the load beam and the second flexure-layer. The preceding subject matter of this paragraph characterizes example 4 of the present disclosure, wherein example 4 also includes the subject matter according to any one of examples 1-3, above.

The first flexure-layer defines a substrate of the flexure, and the second flexure-layer is made of a polyimide material that is applied onto the substrate of the flexure. The preceding subject matter of this paragraph characterizes example 5 of the present disclosure, wherein example 5 also includes the subject matter according to example 4, above.

The head-gimbal assembly further includes an adhesive interposed between the actuator and a third flexure-layer of the flexure and contacting the second flexure-layer and the third flexure-layer. The preceding subject matter of this paragraph characterizes example 6 of the present disclosure, wherein example 6 also includes the subject matter according to any one of examples 4-5, above.

The first flexure-layer, the second flexure-layer, and a third flexure-layer are arranged in a stacked formation in a first direction that is substantially parallel to a depth of the recess. The preceding subject matter of this paragraph characterizes example 7 of the present disclosure, wherein example 7 also includes the subject matter according to any one of examples 4-6, above.

The actuator side includes a surface of the second flexure-layer that is substantially perpendicular to the first direction. The preceding subject matter of this paragraph characterizes example 8 of the present disclosure, wherein example 8 also includes the subject matter according to example 7, above.

The second flexure-layer does not contact the actuator. The preceding subject matter of this paragraph characterizes example 9 of the present disclosure, wherein example 9 also includes the subject matter according to any one of examples 4-8, above.

The second flexure-layer is made of a photosensitive dielectric material. The preceding subject matter of this paragraph characterizes example 10 of the present disclosure, wherein example 10 also includes the subject matter according to any one of examples 4-9, above.

The flexure further includes a recessed portion defining the recess and a non-recessed portion immediately adjacent to the recessed portion and at least partially overlapping with the actuator along the virtual plane. The preceding subject matter of this paragraph characterizes example 11 of the present disclosure, wherein example 11 also includes the subject matter according to any one of examples 1-10, above.

The actuator includes a first actuator. The head-gimbal assembly further includes a second actuator. The recess is a first recess. The flexure further includes a second recess formed in the actuator side and at least partially overlapping with the second actuator along the virtual plane. The preceding subject matter of this paragraph characterizes example 12 of the present disclosure, wherein example 12 also includes the subject matter according any one of examples 1-11, above.

A maximum width of the actuator is less than a maximum width of the recess. The preceding subject matter of this paragraph characterizes example 13 of the present disclosure, wherein example 13 also includes the subject matter according to examples 1-12, above.

The flexure includes a recessed portion defining the recess and a non-recessed portion immediately adjacent to the recess. The actuator does not overlap with the non-recessed portion in the virtual plane. The preceding subject matter of this paragraph characterizes example 14 of the present disclosure, wherein example 14 also includes the subject matter according to examples 1-13, above.

Also disclosed herein is a magnetic storage system that includes a quantity of disks and a head-gimbal assembly. The head-gimbal assembly includes a read-write head and a suspension assembly. The suspension assembly includes a base plate, a load beam attached to the base plate, an actuator configured to cause the read-write head to move toward a disk of the quantity of disks, and a flexure attached to the actuator. The flexure attached to the actuator includes an actuator side facing the actuator and a recess formed in the actuator side and at least partially overlapping with the actuator along a virtual plane that is substantially perpendicular to a length of the load beam. The preceding subject matter of this paragraph characterizes example 15 of the present disclosure.

The magnetic storage system further includes a slider attached to a slider side of the flexure, which is opposite to the actuator side. The slider includes a read-write head configured to at least one of read data from or write data to at least one disk of the quantity of disks. The preceding subject matter of this paragraph characterizes example 16 of the present disclosure, wherein example 16 also includes example 15, above.

The load beam further includes a distal end portion, a proximal end portion, and a hinge interposed between the distal end portion and the proximal end portion. The proximal end portion is attached to the base plate. The flexure is attached to the load beam such that the actuator is positioned over the distal end portion of the load beam. The preceding subject matter of this paragraph characterizes example 17 of the present disclosure, wherein example 17 also includes examples 15-16, above.

Further disclosed herein is a method of manufacturing a head-gimbal assembly of a magnetic storage device. The method includes attaching an actuator to a means for at least partially insetting the actuator on an actuator side of the flexure. The actuator is configured to cause a read-write head attached to the flexure to move. An actuator side of the flexure faces the actuator, and the means for at least partially insetting the actuator at least partially overlaps with the actuator along a virtual plane that is substantially perpendicular to a length of a load beam attached to the flexure. The preceding subject matter of this paragraph characterizes example 18 of the present disclosure.

The means for at least partially insetting the actuator includes a recess formed in the actuator side. The method further includes forming the recess by removing material from a polyimide layer of the flexure. The preceding subject matter of this paragraph characterizes example 19 of the present disclosure, wherein example 19 also includes the subject matter according to example 18, above.

The polyimide layer includes a first polyimide layer, and the method further includes attaching a slider having the read-write head to an additional polyimide layer of the flexure on a slider side of the flexure opposite to the actuator side. The preceding subject matter of this paragraph characterizes example 20 of the present disclosure, wherein example 20 also includes the subject matter according to any one of examples 18-19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims or may be learned by the practice of the subject matter as set forth hereinafter.

### BRIEF DESCRIPTION OF THE DRAWINGS

In order that the advantages of the disclosure will be readily understood, a more particular description of the disclosure briefly described above will be rendered by reference to specific examples that are illustrated in the appended drawings. Understanding that these drawings depict only typical examples of the disclosure and are not therefore to be considered to be limiting of its scope, the subject matter of the present application will be described and explained with additional specificity and detail through the use of the accompanying drawings, in which:

FIG. 1 is a schematic perspective view of a magnetic storage device, according to one or more examples of the present disclosure;

FIG. 2A is an underside view of a head-gimbal assembly of a magnetic storage device, and a detailed view of actuators of the head-gimbal assembly, according to one or more examples of the present disclosure;

FIG. 2B is a cross-sectional side elevation view of a head-gimbal assembly of a magnetic storage device, taken along the plane A-A of FIG. 2A, according to one or more examples of the present disclosure;

FIG. 2C is another cross-sectional side elevation view of a head-gimbal assembly of a magnetic storage device, according to one or more examples of the present disclosure, taken along the plane B-B of FIG. 2A;

FIG. 2D is a perspective view of a cutout of a head-gimbal assembly of a magnetic storage device, the cutout taken along the plane A-A of FIG. 2A, according to one or more examples of the present disclosure;

FIG. 3A is a cross-sectional side elevation view of a head-gimbal assembly of a magnetic storage device having a flexure with a recess offset from an actuator, taken along the plane A-A of FIG. 2A, according to one or more examples of the present disclosure;

FIG. 3B is another cross-sectional side elevation view of a head-gimbal assembly of a magnetic storage device having a flexure with a recess offset from an actuator, taken along the plane B-B of FIG. 2A, according to one or more examples of the present disclosure;

FIG. 3C is a perspective view of a cutout of a head-gimbal assembly of a magnetic storage device, the cutout taken along the plane A-A of FIG. 2A, according to one or more examples of the present disclosure; and

FIG. 4 is a flow chart of a method of manufacturing a head-gimbal assembly of a magnetic storage device, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure. However, absent an express correlation to indicate otherwise, an implementation may be associated with one or more examples.

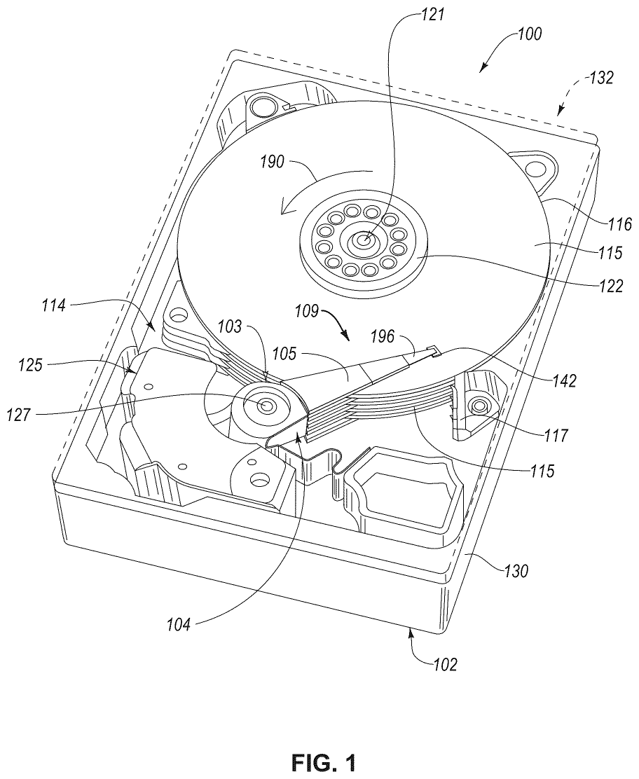

Referring to FIG. 1, a magnetic storage device 100, according to one example, is depicted as a hard disk drive (HDD). However, in other examples, the magnetic storage device 100 can be any of various magnetic storage devices without departing from the essence of the subject matter of the present disclosure. The magnetic storage device 100 includes a housing 102 that seals or encloses an interior cavity 114 defined within the housing. The housing 102 includes a base 130 and a cover 132 (shown in dashed lines so as not to obscure internal features of the magnetic storage device 100 within the interior cavity 114 of the housing 102). The cover 132 is coupled to the base 130 to enclose the interior cavity 114 from the environment exterior to the housing 102. In some implementations, a seal or gasket is positioned between the base 130 and the cover 132 to promote a seal between the base 130 and the cover 132. In some examples, the base 130 is made of a metallic material, such as stainless steel.

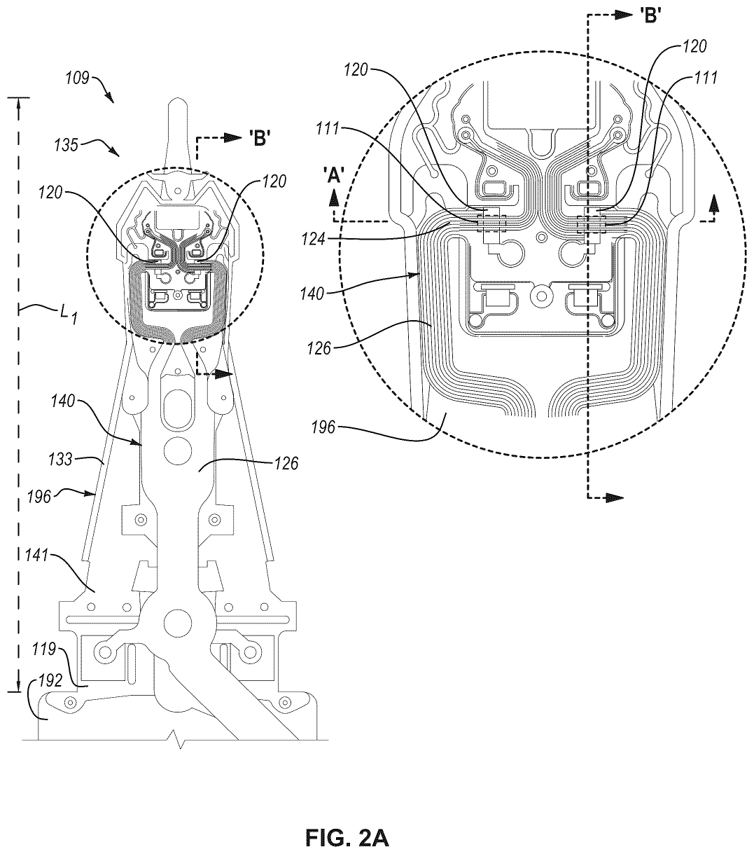

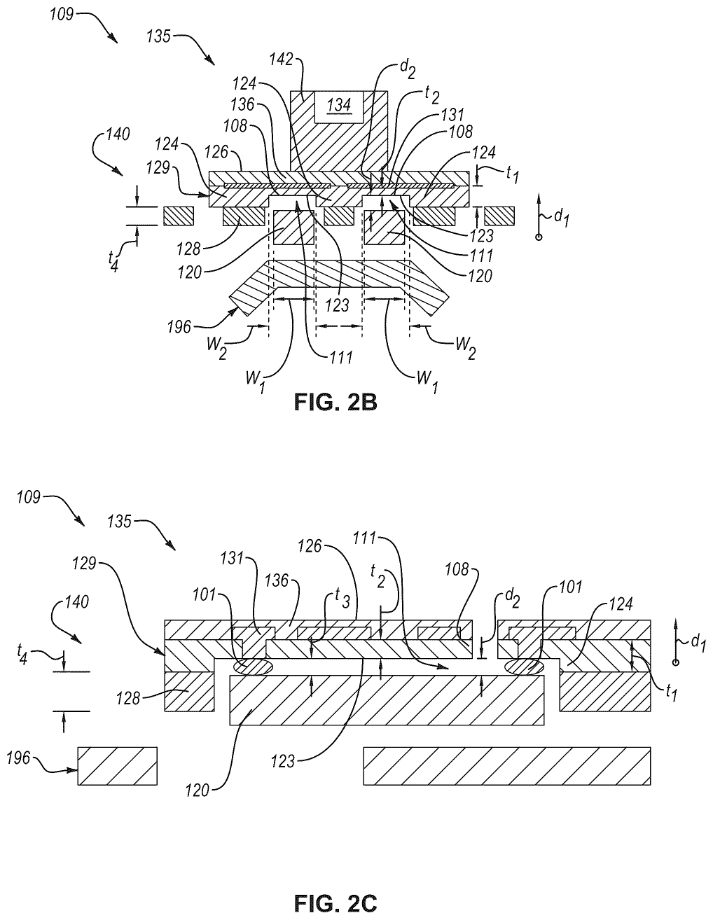

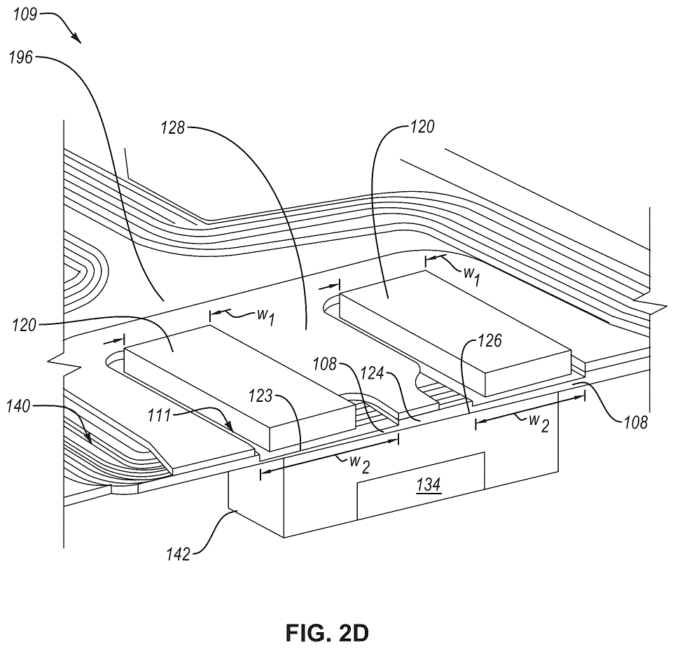

The magnetic storage device 100 includes various features located within the interior cavity 114 of the housing 102. In some examples, the magnetic storage device 100 includes a carriage 103, disks 115, a spindle motor 121, and a voice coil motor (VCM) 125 within the interior cavity 114. Referring to FIGS. 1 and 2A, the carriage 103 includes a head stack assembly 107, which includes a plurality of carriage arms 105 and at least one head-gimbal assembly 109 (e.g., suspension), coupled to the distal tip of each carriage arm of the plurality of carriage arms 105. Each head-gimbal assembly 109 includes a suspension assembly 135 and a slider 142. The slider 142 includes at least one read-write head coupled to (e.g., embedded in) a housing of the slider 142. Although the magnetic storage device 100 in FIG. 1 is shown to have five carriage arms 105 and four disks 115, in other examples, the magnetic storage device 100 can have fewer or more than five carriage arms 105 or fewer or more than four disks 115. In one example, each side of each carriage arm 105 facing a disk 115 has a head-gimbal assembly 109 (e.g., each one of bottom and top carriage arms 105 can have one head-gimbal assembly 109 and each one of middle carriage arms 105, between the bottom and top carriage arms 105, can have two head-gimbal assemblies 109). Similarly, although the magnetic storage device 100 is shown to have one spindle motor 121 and one VCM 125, in other examples, the magnetic storage device 100 can have any number of spindle motors 121 and VCMs 125.

The spindle motor 121 is coupled to the base 130. Generally, the spindle motor 121 includes a stationary portion non-movably fixed relative to the base 130 and a spindle that is rotatable relative to the stationary portion and the base 130. Accordingly, the spindle of the spindle motor 121 can be considered to be part of or integral with the spindle motor. Generally, the spindle motor 121 is operable to rotate the spindle relative to the base 130. The disks 115, or platters, are co-rotatably fixed to the spindle of the spindle motor 121 via respective hubs 122, which are co-rotatably secured to respective disks 115 and the spindle. As the spindle of the spindle motor 121 rotates, the disks 115 correspondingly rotate. In this manner, the spindle of the spindle motor 121 defines a rotational axis of each disk 115. The spindle motor 121 can be operatively controlled to rotate the disks 115, in a rotational direction 190, a controlled amount at a controlled rate.

Each one of the disks 115 may be any of various types of magnetic recording media. Generally, in one example, each disk 115 includes a substrate and a magnetic material applied directly or indirectly onto the substrate. For example, the magnetic material of the disks 115 may be conventional granular magnetic recording disks or wafers that have magnetic layer bits with multiple magnetic grains on each bit. In granular magnetic media, all of the bits are co-planar, and the surface 116 of the disk is substantially smooth and continuous. In one example, each bit has a magnetic dipole moment that can either have an in-plane (longitudinal) orientation or an out-of-plane (perpendicular) orientation.

As the disks 115 rotate in a read-write mode, the VCM 125 electromagnetically engages voice coils of the carriage arms 105 to rotate the carriage arms 105, and the head-gimbal assemblies 109, which are coupled to the carriage arms 105, relative to the disks 115 in a rotational direction along a plane parallel to read-write surfaces of the disks 115. The carriage arms 105 can be rotated to position the read-write head of the head-gimbal assemblies 109 over a specified radial area of the read-write surface 116 of a corresponding disk 115 for read and/or write operations. The VCM 125 is fixed to the base 130 in engagement with the voice coils of the carriage arms 105, which are rotatably coupled to the base 130 via a spindle 127 extending through the carriage 103. Generally, the spindle 127 defines a rotational axis about which the carriage arms 105 rotate when actuated by the VCM 125.

The carriage arms 105 are non-movably fixed to (e.g., integrally formed as a one-piece unitary monolithic body with) and extend away from a base of the carriage 103 in a spaced-apart manner relative to each other. In some implementations, the carriage arms 105 are spaced an equi-distance apart from each other and extend parallel relative to each other. A respective one of the disks 115 is positioned between adjacent carriage arms 105. In an idle mode (e.g., when read-write operations are not being performed), the VCM 125 is actuated to rotate the carriage arms 105, in a radially outward direction relative to the disks 115, such that the head-gimbal assemblies 109 are parked or unloaded onto a ramp support 117 secured to the base 130.

Referring to FIGS. 1, 2B, and 3A, the read-write head 134 embedded in the slider 142 includes at least one read transducer and at least one write transducer. The read transducer is configured to detect magnetic properties (e.g., magnetic bit patterns) of a disk 115 and convert the magnetic properties into an electrical signal. In contrast, the write transducer changes the magnetic properties of a disk 115 responsive to an electrical signal. For each head-gimbal assembly 109, the electrical signals are transmitted from and to the read-write head 134 via electrical traces or lines formed in or coupled to the slider 142 and the flexure 140 (see, e.g., the third layer 131 of 2B-3B). The electrical traces of the slider 142 and the flexure 140 are electrically interconnected to facilitate transmission of electrical signals between the read-write head and a flex connector 104 of the magnetic storage device 100, which is in communication with a control module of the magnetic storage device 100 (see, e.g., FIG. 1). The control module is configured to process the electrical signals and facilitate communication of the electrical signals between the magnetic storage device 100 and one or more external computing devices.

Generally, the control module includes software, firmware, and/or hardware used to control operation of the various components of the magnetic storage device 100. The control module may include a printed circuit board on or in which the hardware is mounted. Solder weldments are utilized to electrically connect corresponding electrical contact pads (and corresponding electrical traces) of the slider 142 and the flexure 140.

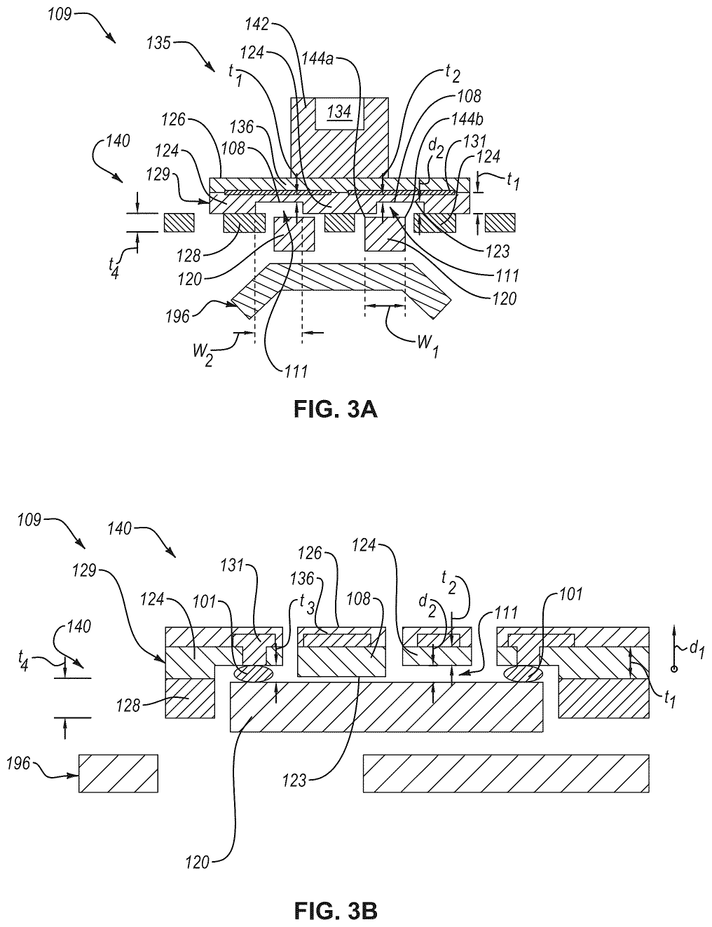

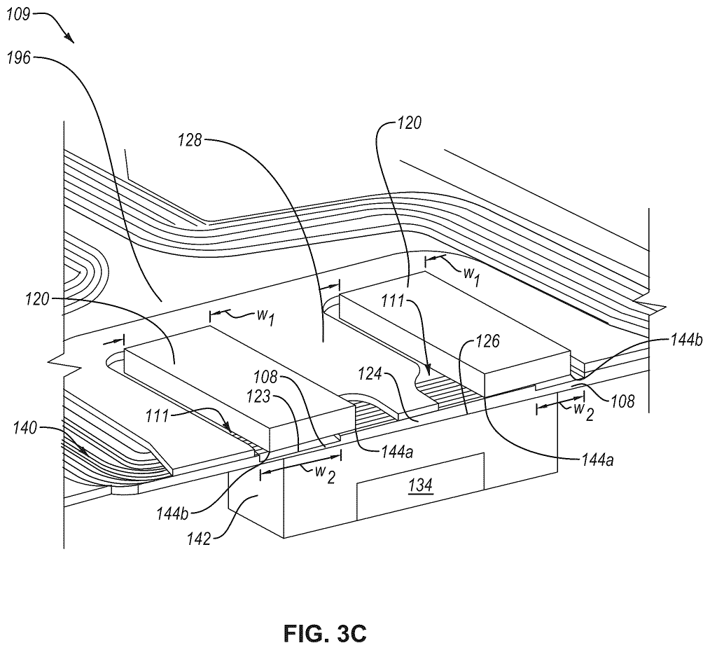

Referring to FIGS. 2A-3C, in some implementations, the head-gimbal assembly 109 also includes an actuator 120 that is selectively operable to move the read-write head 134. The actuator 120 can, in some examples, transmit force to the flexure 140, which can help to distribute force to the actuator and enable more precise control of the motion of the read-write head 134.

FIG. 2A is an underside view of the head-gimbal assembly 109 of the magnetic storage device 100, according to one or more examples of the present disclosure. As used herein, the term “underside” refers to any side of the head-gimbal assembly 109 (e.g., an underside of the suspension assembly 135) facing a read/write surface 116 of a disk 115 from which the read/write head 134 is to read data from and/or write data to. The head-gimbal assembly 109 includes the suspension assembly 135 and the read-write head 134. In some examples of the present disclosure, the suspension assembly 135 includes the base plate 192 and the load beam 196 with a distal end portion 133, undersides of which are illustrated in FIG. 2. The base plate 192 spans between and couples together a distal end portion 133 of the load beam 196 and the carriage arm 105. The load beam 196 is coupled to and bends with respect to a base plate 192 of the suspension assembly 135, via a hinge 141 of the load beam 196. In some examples, the hinge 141 includes two hinges on either side of a gap in the load beam 196. The hinge 141 biases the load beam 196 towards a surface 116 of at least one disk 115 of the quantity of disks 115 to enable a read-write head 134 of a distal end portion 133 of the carriage arm 105 to read data from and/or write data to the corresponding one of the disks 115. In some examples, the read-write head 134 floats above the read/write surface 116 as the disk rotates relative to the read/write head 134.

In some examples, the load beam 196 is made of resiliently flexible material, such as a metallic material. When bent, the hinge 141 works as a spring to generate force (referred to herein as “gram load”) to urge the head 134 of the head-gimbal assembly 109 towards the surface of the disk 115 into a position such that the flying height between surface and the read/write head 134 is minimal. This is accomplished, for example, through forced air or another gas (e.g., helium). A gap between the read-write head 134 and the disk 115 may be referred to herein as a “flying height” or “floating height. ” It is often preferrable to minimize this gap and/or to stabilize it to maximize signal quality of data transmitted between the disk 115 and the read-write head 134. In some examples, the flying height is approximately equal to or less than five nanometers (“nm”). However, examples of the present disclosure are not so limited.

The suspension assembly 135 also includes the flexure 140, which extends along the undersides of the base plate 192 and the load beam 196. The flexure 140 includes an actuator side 123 facing the actuator 120. Direct contact between actuators 120 and the flexure 140 can lead to increased friction, reducing overall efficiency of the actuator 120 and potentially contributing to premature wear and/or failure. Additionally, direct flexure-actuator contact can introduce unwanted vibrations and/or noise, which can interfere with the actuator 120's performance. The force of contact can also contribute to deformation and/or damage to the flexure 140. As such, reducing direct flexure-actuator contact can help to improve performance and/or decrease wear to the actuator 120 and/or flexure 140.

Examples of the present disclosure include a flexure 140 having a recess 111 in an actuator side 123 of the flexure 140 that faces the actuator 120. The recess 111 at least partially overlaps with the actuator 120 along the plane A-A to help reduce direct contact between the flexure 140 and the actuator 120. In some examples, the flexure 140 has a reduced thickness at a recessed portion 108 of the flexure 140. As used herein, “recessed portion” of a feature refers to any portion of the feature that includes a recess 111. Hence, the recessed portion 108 of the flexure 140 is defined by the recess 111 and is the portion of the flexure 140 approximately within the area shown in dashed line in FIG. 2A.

As shown in FIGS. 2B-D and 3A-C, in some examples, the flexure 140 is a muti-layer flexure including, for example, a first layer 128, a second layer 129, a third layer 131, and/or a fourth layer 136. The flexure layers 128, 129, 131, and 136, in some examples, are arranged in a stacked formation in a first direction d₁. As will be described herein, portions of various layers 128, 129, 131, and/or 136 have various thicknesses in order to minimize flexure-actuator contact. In some examples, the recess 111 of the flexure 140 is a recess 111 in the second layer 129. As used herein, the actuator 120 being attached to the flexure 140 includes, in some examples, the actuator 120 being a component of the flexure 140 and being indirectly attached to at least one of the various layers 128, 129, 131, and/or 136 of the flexure 140.

In some examples, the first layer 128 is formed directly onto the load beam 196. Similarly to the load beam 196, the first layer 128 is often made of stainless steel or other similar materials and has a thickness that is greater than other layers of the multi-layer flexure 140. In some examples, the first layer 128 is made of a metallic material. For instance, the first layer 128 is a sheet of stainless steel, in some examples. According to some examples, the first layer 128 has a thickness t₄ of approximately 20 micrometers (“μm”). In some examples, after the multi-layer flexure 140 is formed, the first layer 128 is attached to the load beam 196 to attach the overall flexure 140 to the load beam. In other words, the first layer 128 is positioned directly adjacent to the load beam 196. As shown in FIGS. 2B-3B, in some examples, the first layer 128 does not contact the actuator 120. The first layer 128, in some examples, is a substrate of the flexure 140.

The second layer 129 of the flexure 140 is formed (e.g., applied) onto the first layer 128. In some examples, the second layer 129 is made of a dielectric and/or photosensitive material, such as a liquid polyimide. As illustrated in FIGS. 2B and 3A, the second layer 129 forms a barrier between the first layer 128 and a third layer 131.

This barrier helps to promote maintenance of signal quality. The thickness of the second layer 129 is positively correlated with signal quality. Referring to FIGS. 3A-C, in some examples, a portion of the second layer 129 overlaps with an actuator 120 in a plane A-A substantially perpendicular to a length L₁ of the load beam 196. However, as discussed above, reducing or avoiding contact between the second layer 129 and the flexure 140 can be beneficial. As such, the present disclosure includes a flexure 140 having a recess 111 positioned to help reduce flexure-actuator contact.

In some examples, the third layer 131 is made of copper. In some examples, the copper of the third layer 131 has a high purity, making it less stiff and more flexible. For example, the third layer 131 includes copper with a purity of over ninety-nine percent, which is similar to the purity of electronic-grade copper foil. In some examples, the third layer 131 includes portions of one or more signal traces for the flexure 140. In some examples, the flexure 140 includes a signal trace (sometimes referred to as a “circuit trace”) to conduct signals from the read/write head 134 to other components of the device 100. Although this trace is often made of copper and/or copper foil, examples of the present disclosure are not so limited. For example, in some examples, a trace is made of aluminum, gold, or any combination thereof.

In some examples, the flexure 140 includes a fourth layer 136 disposed between the traces of the third layer 131 and the slider 142. Referring to FIGS. 2B and 3A, the slider 142, in some examples, is coupled to the flexure at the fourth layer 136.

The fourth layer, in some examples, is made of a material similar to the material of the second layer 129. The fourth layer 136 can be made of, for example, a flexible material, such as a polyimide. The fourth layer 136, in some examples, is made of an insulating, heat-resistant material.

Referring to FIGS. 2C-2D and FIGS. 3B-3C, the flexure 140, in some examples, is directly and/or indirectly attached to the actuators 120. The flexure 140 includes an actuator side 123 facing the actuators 120 and the load beam 196. The flexure 140 also includes a slider side 126 opposite to the actuator side 123. The slider side 126 faces and, in some examples, is attached to the slider 142. As such, in some examples, the slider side 126 faces a read-write surface of a disk 115, which the corresponding read/write head 134 of the head-gimbal assembly 109 is reading data from and/or writing data to.

The actuator side 123, in some examples, includes exposed portions of the second layer 129. The exposed portions include, for example, surfaces of the second layer 129 not covered by the first layer 128. In some examples, the surfaces of the second layer 129 extend substantially perpendicular to a direction d₁ in which the layers of the flexure 140 are stacked. The recess 111 is formed in the actuator side 123 to face the actuator 120. The flexure 140 is recessed away from the actuator 120.

FIGS. 2B and 3A are cross-sectional side elevation views of two examples of the head-gimbal assembly 109, taken along the plane A-A of FIG. 2A. The plane A-A is substantially perpendicular to the length L₁ of the load beam 196. Referring to FIGS. 2B and 3A, in some examples, the recess 111 at least partially overlaps with the actuator 120 along the virtual plane A-A. The recess 111 and the actuator 120 both pass through at least one common plane that is substantially perpendicular to the virtual plane A-A (e.g., the plane B-B shown in FIG. 2A). In one or more examples, the actuator 120 does not overlap with the first layer 128 in the virtual plane A-A. The recess 111, in some examples, is formed in the second layer 129.

Referring back to FIG. 2A, in some examples, the load beam 196 includes the distal end potion 133 and the proximal end portion 119, with the hinge 141 interposed between the distal end portion 133 and the proximal end portion 119. In some examples, the flexure 140 is attached to the load beam 196 such that the actuator 120 is positioned over the distal end portion 133 of the load beam 196. In such examples, the recess 111 of the flexure 140 is also positioned over the distal end portion 133 of the load beam 196. The recess 111 and the actuator 120, in some examples, are confined to the distal end portion 133 and do not include any portions extending over the proximal end portion 119. As shown, the recess 111 helps facilitate an at least partial insetting of the actuator 120 into the flexure 140.

In one or more examples, a depth d₂ of the recess 111, defined as a difference in thicknesses between the recessed portion 108 and a non-recessed portion 124 immediately adjacent to the recessed portion 108, is substantially parallel to the direction d₁ in which the layers of the flexure 140 are stacked. In some examples, the second layer 129 is recessed away from the first layer 128, actuator 120, and/or load beam 196. Referring to FIG. 3B, in some examples, a depth d₂ of the recess 111 varies along the plane ‘B-B.’

The recessed portion 108 has a thickness t₂ that is less than a thickness t₁ of the non-recessed portions 124. A ratio of the non-recessed thickness t₁ to the recessed thickness t₂ is, in some examples, between, and inclusive of, 1.2 and 5. In some examples, the sum of the depth d₂ of the recess and the thickness t₂ of the recessed portion 108 is approximately equal to the thickness t₁ of the non-recessed portion 124. In some examples, the recessed portion 108 and the non-recessed portion 124 are flush at the slider side 126 but not at the actuator side 123.

FIG. 2C is another cross-sectional side elevation view of a head-gimbal assembly 109 of a magnetic storage device 100, according to one or more examples of the present disclosure, taken along the plane B-B of FIG. 2A. FIG. 3B is another cross-sectional side elevation view of another example of the head-gimbal assembly 109, taken along the plane B-B of FIG. 2A.

Referring to FIGS. 2C and 3B, in some examples, the suspension assembly 135 includes an adhesive 101 disposed between the actuator 120 and the flexure 140 at a location within the recess 111. The adhesive 101, in some examples, is made of an electrically conductive material. In some examples, the adhesive 101 establishes an electrical connection between the actuator 120 and the flexure 140, enabling receipt of signals by the flexure 140 from the actuator 120. The adhesive 101, in some examples, is made of a thermally conductive material.

As shown in FIGS. 2C and 3B, in some examples, the adhesive 101 partially fills the recess 111. The adhesive 101, in some examples, does not completely fill the recess 111. In some examples, the adhesive 101 is received by the recess 111 and fills less than half of a total volume of the recess 111. In some examples, the adhesive 101 is interposed between the actuator 120 and the flexure 140 at more than one location within the recess 111. As shown in FIGS. 2C and 3B, in some examples, the adhesive 101 is disposed within the recess 111 at two locations. In some examples, the adhesive 101 is disposed within the recess 111 at a quantity of locations that is equal to the quantity of portions of the third layer 131 that extend to the actuator side 123 within the recess. For example, as shown in FIGS. 2C and 3B, the third layer 131 extends to the actuator side 123 and is exposed to the recess 111 in two locations, and the adhesive 101 is disposed within the recess 111 in these two separate locations.

In some examples, the adhesive 101 directly contacts the actuator 120 and extends through the depth d₂ of the recess 111 to directly contact the flexure 140. The adhesive 101 contacts any combination of the layers of the flexure 140. For example, referring to FIGS. 2C and 3B, the adhesive 101 contacts the third layer 131 to provide electrical connection between the actuator 120 and the traces of the third layer 131. In some examples, the adhesive 101 contacts only the third layer 131 and does not directly contact any other layers of the flexure (e.g., the adhesive 101 does not contact the first layer 128 or the second layer 129). The third layer 131, in some examples, extends through the second layer 129 to the actuator side 123 of the flexure 140 within a recess 111. In some examples, the adhesive 101 contacts both the second layer 129 and the third layer 131 within the recess 111.

In some examples, the adhesive 101 is completely or mostly contained within the recess 111. In some examples, the adhesive 101 has a thickness t₃ that does not exceed the depth d₂ of the recess. In some examples, the adhesive 101 has a thickness t₃ that does not significantly exceed the depth d₂ of the recess 111. In some examples, the thickness t₃ of the adhesive is not greater than a sum of the recess depth d₂ and the thickness t₄ of the first layer 128. In some examples, a ratio of the adhesive thickness t₃ to the recess depth d₂ is not greater than 1.5.

In some examples, the adhesive 101 is made of a malleable material. As such, as used herein, the “thickness” t₃ of the adhesive 101 refers to the thickness t₃ of the adhesive 101 when the adhesive 101 is received by the recess 111 and contacts both the actuator 120 and the flexure 140 during operation of the magnetic storage device 100.

Referring to FIGS. 2B, 2D, 3A, and 3C, in some examples, the suspension assembly 135 includes more than one recess 111. In some examples, a quantity of recesses 111 positioned over the distal end portion 133 of the load beam 196 is equal to a quantity of actuators 120 positioned over the distal end portion 133 of the load beam 196. The suspension assembly 135, in some examples, includes two recesses 111 formed in the same flexure 140 and two actuators 120 positioned over the distal end portion 133 of the load beam 196. Although two recesses 111 and two actuators 120 are shown corresponding to one flexure 140 in FIGS. 2B, 2D, 3A, and 3C, examples of the present disclosure are not so limited and may include more or fewer recesses 111 and/or actuators 120.

Referring to FIGS. 2B-D, in some examples, the flexure 140 does not directly contact the actuator 120. Referring to FIG. 2C, in some examples, the flexure 140 indirectly contacts the actuator 120 through the adhesive 101 and is suspended over the actuator 120 by the adhesive 101. In some examples, a recessed layer (e.g., the second layer 129) does not contact the actuator 120. Referring to FIG. 2B, in some examples, the maximum width w₁ of the actuator 120 is less than a maximum width w₂ of the recess 111. In some examples, the actuator 120 is positioned entirely over the recess 111 in the plane A-A, and a maximum width w₁ of the actuator 120 is less than a maximum width w₂ of the recess 111. In some examples, the adhesive 101 and/or another component of the suspension assembly 135 provides separation between the flexure 140 and the actuator 120 in the direction d₁, such that the actuator 120 does not contact even the non-recessed portions 124 of the flexure 140. In some examples, the actuator 120 is positioned between gaps in the first layer 128 so as not to contact the first layer 128.

In some examples, the actuator 120 is positioned to be substantially centered with respect to a corresponding recess 111. Referring to FIG. 2B, in some examples, the actuator 120 does not overlap with the non-recessed portions 124 along a plane A-A in which the actuator 120 overlaps with the recess 111.

Referring to FIGS. 3A-C, in other examples, the actuator 120 overlaps at least partially with at least one non-recessed portion 124 of the flexure 140 in the plane A-A. In some examples, the actuator 120 is offset along the plane A-A with respect to the recess 111. In some examples, the actuator 120 still does not contact the flexure 140, even with an overlap of the actuator 120 and the non-recessed portion 124. Separation between the flexure 140 and the actuator 120 is maintained, in some examples, via the adhesive 101.

In some examples, the actuator 120 is offset with respect to the recess 111 in the plane A-A and overlaps with a non-recessed portion 124 of the flexure 140.

Referring to FIG. 3C, in some examples, the actuator 120 is shaped similarly to a rectangular prism. In some examples, a first corner 144a of the actuator 120 overlaps with the non-recessed portion 124 of the flexure 140, while another corner 144b of the actuator 120 does not overlap with the non-recessed portion 124 of the flexure 140. In some examples, a corner 144b of the actuator 120 overlaps with the recess 111, and another corner 144a of the actuator 120 does not. In some examples, although the actuator 120 overlaps with the non-recessed portions 124 of the flexure 140 in the plane A-A, the actuator 120 still does not directly contact the flexure 140, due to the clearance provided by the adhesive 101 interposed between the actuator 120 and the flexure 140. A distance between the flexure 140 and the corner 144b is greater than a distance between the flexure 140 and the corner 144a.

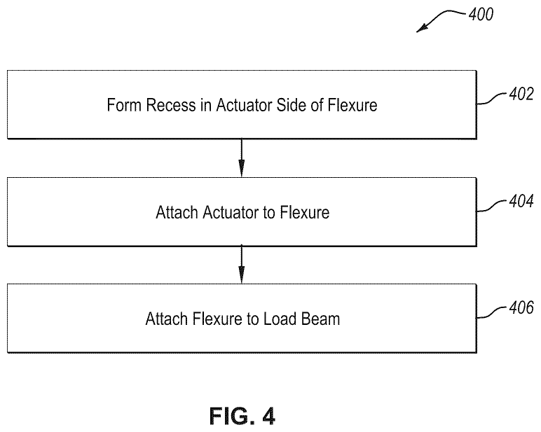

FIG. 4 is a flow chart of a method 400 of manufacturing a head-gimbal assembly 109 of a magnetic storage device 100, according to one or more examples of the present disclosure. Specifically, the method 400 includes manufacturing a flexure 140 of the suspension assembly 135 of the magnetic storage device 100. Those of skill in the art will appreciate that any combination of steps illustrated in FIG. 4, and/or described herein, may be employed.

The method 400 includes a step 404 of attaching the actuator 120 to a means for receiving the actuator 120 on an actuator side 123 of the flexure 140. In some examples, the means for receiving the actuator 120 includes the recess 111. In some examples, the means for receiving the actuator 120 is a means for indirectly attaching the actuator 120 to the flexure 140 (e.g. via the adhesive 131). In some examples, the method 400 includes attaching the actuator 120 to the flexure 140 such that an actuator side 123 of the flexure 140 faces the actuator and the recess 111, formed in the actuator side 123, at least partially overlaps with the actuator along the plane ‘A-A.’ The plane A-A, in some examples, is substantially perpendicular to the length L₁ of the load beam 196 when the load beam 196 is attached to the flexure 140. In some examples, attaching 404 the flexure 140 to the actuator 120 includes attaching the flexure 140 and the actuator 120 via an adhesive 101.

In some examples, the method 400 optionally includes the additional step of forming 402 the recess 111 in the actuator side 123 of the flexure 140. In some examples, the method 400 includes forming 402 the recess 111 before attaching the flexure 140 and the actuator 120. In some examples, forming 402 the recess 111 includes removing material from the second layer 129 (e.g., removing polyimide material from the flexure 140).

Forming 402 the recess 111 includes, in some examples, forming the recess 111 in the second layer 129 via various methods. In some examples, after the second layer 129 is formed onto the first layer 128, a mask is placed over the second layer 129. Although the phrase “placed over” is used herein, examples of the present disclosure are not so limited. For example, the mask can be formed onto the second layer. This mask includes a portion that is positioned over the desired recessed portion 108 of the flexure 140. This portion of the mask differs in translucency from a remaining portion of the mask. In some examples, the mask is a glass photomask and/or a halftone mask. For example, the portion of the mask placed over the desired recessed portion 108 is a halftone glass mask, and the remaining portion(s) of the mask are full glass masks.

In some examples, the mask is an opaque plate having one or more apertures or transparent or translucent portions. Thus, light may be shined through the mask. In some examples, the portion aligned with the desired recessed portion 108 is more translucent than the remaining portion(s). In some examples, the greater translucency is attributed at least partially to a greater number and/or concentration of apertures and/or transparent portions in various portions of the masks.

In some examples, forming 402 the recess 111 includes irradiating light through the mask. Light is irradiated through both a recessing portion and a non-recessing portion of the mask. In some examples, this is done through a lens. Although some portions of the mask may be more translucent than other portions, light may still be irradiated through the entire mask. In some examples, the method includes removing the mask from the second layer 129 and etching away or removing residue from the second layer 129 such that a recessed portion 108 of the second layer 129 has a thickness t₂ that is less than a thickness t₁ of a remaining, non-recessed portion 124 of the second layer 129. In some examples, forming 402 the recess 111 includes forming a photoresist material onto the second layer 129 and etching one or more openings into the photoresist material to expose portions of the second layer 129.

In some examples, the method 400 additionally includes attaching the slider 142 to the fourth layer 136 of the flexure 140 on the slider side 126, opposite to the actuator side 123.

As used herein, the term “layers” may be used to describe multiple consecutive or non-consecutive layers. However, it may also be used to describe multiple portions of a layer of material. For example, as shown in FIGS. 2B-D and 3A-C, the second layer 129 includes multiple portions with different thicknesses, including portions 108 and 124. Portions 108 and 124 may be referred to collectively as “second layers 129” and/or as “the second layer 129.”

In the above description, certain terms may be used such as “up,” “down,” “upper,”“lower,”“horizontal,”“vertical,”“left,”“right,”“over,”“under”and the like. These terms are used, where applicable, to provide some clarity of description when dealing with relative relationships. But, these terms are not intended to imply absolute relationships, positions, and/or orientations. For example, with respect to an object, an “upper”surface can become a “lower”surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two. ”

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to”and/or as being “operative to”perform that function.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A head-gimbal assembly for a magnetic storage device, the head-gimbal assembly comprising:
a load beam;
a read-write head;
an actuator configured to cause the read-write head to move; and
a flexure attached to the actuator and comprising:
an actuator side facing the actuator; and
a recess formed in the actuator side and at least partially overlapping with the actuator along a virtual plane that is substantially perpendicular to a length of the load beam.

2. The head-gimbal assembly of claim 1, further comprising an adhesive disposed between the actuator and the flexure at a location within the recess such that the adhesive partially fills the recess, wherein the adhesive is made of an electrically conductive material.

3. The head-gimbal assembly of claim 1, wherein a ratio between a thickness of a non-recessed portion of the flexure, immediately adjacent to the recess, to a thickness of a recessed portion of the flexure, defined by the recess, is between, and inclusive of, 1.2 and 5.0.

4. The head-gimbal assembly of claim 1, wherein:
the flexure further comprises a first flexure-layer made of a first material and a second flexure-layer made of a second material that is different than the first material;
the recess is formed in the second flexure-layer; and
the flexure is attached to the load beam such that the first flexure-layer is interposed between the load beam and the second flexure-layer.

5. The head-gimbal assembly of claim 4, wherein:
the first flexure-layer defines a substrate of the flexure; and
the second flexure-layer is made of a polyimide material that is applied onto the substrate of the flexure.

6. The head-gimbal assembly of claim 4, further comprising an adhesive interposed between the actuator and a third flexure-layer of the flexure and contacting the second flexure-layer and the third flexure-layer.

7. The head-gimbal assembly of claim 4, wherein the first flexure-layer, the second flexure-layer, and a third flexure-layer are arranged in a stacked formation in a first direction that is substantially parallel to a depth of the recess.

8. The head-gimbal assembly of claim 7, wherein the actuator side comprises a surface of the second flexure-layer substantially perpendicular to the first direction.

9. The head-gimbal assembly of claim 4, wherein the second flexure-layer does not contact the actuator.

10. The head-gimbal assembly of claim 4, wherein the second flexure-layer is made of a photosensitive dielectric material.

11. The head-gimbal assembly of claim 1, wherein the flexure further comprises:
a recessed portion defining the recess; and
a non-recessed portion immediately adjacent to the recessed portion and at least partially overlapping with the actuator along the virtual plane.

12. The head-gimbal assembly of claim 1, wherein:
the actuator comprises a first actuator;
the head-gimbal assembly further comprises a second actuator;
the recess is a first recess; and
the flexure further comprises a second recess formed in the actuator side and at least partially overlapping with the second actuator along the virtual plane.

13. The head-gimbal assembly of claim 1, wherein a maximum width of the actuator is less than a maximum width of the recess.

14. The head-gimbal assembly of claim 1, wherein:
the flexure comprises a recessed portion defining the recess and a non-recessed portion immediately adjacent to the recess; and
the actuator does not overlap with the non-recessed portion in the virtual plane.

15. A magnetic storage system, comprising:
a quantity of disks; and
a head-gimbal assembly, comprising:
a read-write head; and
a suspension assembly comprising:
a base plate;
a load beam attached to the base plate;
an actuator configured to cause the read-write head to move toward a disk of the quantity of disks; and
a flexure attached to the actuator and comprising:
an actuator side facing the actuator; and
a recess formed in the actuator side and at least partially overlapping with the actuator along a virtual plane that is substantially perpendicular to a length of the load beam.

16. The magnetic storage system of claim 15, further comprising a slider attached to a slider side of the flexure, which is opposite to the actuator side, wherein the slider comprises a read-write head configured to at least one of read data from or write data to at least one disk of the quantity of disks.

17. The magnetic storage system of claim 15, wherein:
the load beam further comprises a distal end portion, a proximal end portion, and a hinge interposed between the distal end portion and the proximal end portion;
the proximal end portion is attached to the base plate; and
the flexure is attached to the load beam such that the actuator is positioned over the distal end portion of the load beam.

18. A method of manufacturing a head-gimbal assembly of a magnetic storage device, the method comprising:
attaching an actuator to a means for at least partially insetting the actuator on an actuator side of a flexure, wherein the actuator is configured to cause a read-write head attached to the flexure to move,
wherein the actuator side of the flexure faces the actuator and the means for at least partially insetting the actuator at least partially overlaps with the actuator along a virtual plane that is substantially perpendicular to a length of a load beam attached to the flexure.

19. The method of claim 18, wherein:
the means for at least partially insetting the actuator comprises a recess formed in the actuator side; and
the method further comprises forming the recess by removing material from a polyimide layer of the flexure.

20. The method of claim 19, wherein:
the polyimide layer comprises a first polyimide layer; and
the method further comprises attaching a slider having the read-write head to an additional polyimide layer of the flexure on a slider side of the flexure opposite to the actuator side.
